(19) United States
(12) Patent Application Publication
(10) Pub. No.: US 2013/0132063 A1
(43) Pub. Date: May 23, 2013

(54) SYSTEMS AND METHODS FOR DEBUGGING JUST-IN-TIME STATIC TRANSLATION IN AN EMULATED SYSTEM

(71) Applicants: Michael J. Rieschl, (US); Mitchell A. Bauman, (US); Feng-Jung Kao, (US); Edward Lusienski, (US); James R. McBreen, (US); James F. Merten, (US); Thomas L. Nowatzki, (US); David W. Schroth, (US); Scott L. Titus, (US); Judge Yohn, (US)

(72) Inventors: Michael J. Rieschl, (US); Mitchell A. Bauman, (US); Feng-Jung Kao, (US); Edward Lusienski, (US); James R. McBreen, (US); James F. Merten, (US); Thomas L. Nowatzki, (US); David W. Schroth, (US); Scott L. Titus, (US); Judge Yohn, (US)

(21) Appl. No.: 13/299,452

(22) Filed: Nov. 18, 2011

(51) Int. Cl. G06F 9/455; G06F 9/45

(52) U.S. Cl. 703/28

(57) ABSTRACT

Systems and methods for testing and validation of translated memory banks used in an emulated system are disclosed. One method includes translating one or more banks of non-native instructions into one or more banks of native instructions executable in a computing system having a native instruction set architecture. The one or more banks of non-native instructions define one or more tests of execution of a non-native instruction set architecture. The method also includes loading a memory with instructions and data defined according to the non-native instruction set architecture and addressed by the one or more tests, and triggering, by an emulator, execution of the translated one or more banks of native instructions. The method further includes, upon detection of an error during execution of the translated one or more banks of native instructions, identifying an error in execution of the non-native instruction set architecture by the computing system.

### TECHNICAL FIELD

The present disclosure relates generally to translation of computing instructions for native execution of software written for a non-native instruction set architecture. In particular, the present disclosure relates to systems and methods for debugging just-in-time translation of instructions in an emulated system.

### BACKGROUND

Many software applications, in particular those that require a large degree of data security and recoverability, are traditionally supported by mainframe data processing systems. Such software applications may include those associated with utility, transportation, finance, government, and military installations and infrastructures. Such applications are generally supported by CMOS based mainframe systems, because mainframes provide a large degree of data redundancy, enhanced data recoverability features, and sophisticated data security features. These mainframes implement proprietary instruction sets and architectures.

As “off-the-shelf” commodity data processing systems have increased in processing power, there has been movement towards using such systems to support industries that historically employed mainframes for their data processing needs. These computer systems may be used to update legacy data, which may include records from any of the aforementioned sensitive types of applications. This scenario presents several challenges.

First, as previously alluded to, the Operating Systems (OS's) that are generally available on commodity-type systems do not include the security and protection mechanisms needed to ensure that legacy data is adequately protected. For instance, when a commodity-type OS such as Windows or Linux experiences a critical fault, the system must generally be entirely rebooted. This involves reinitializing the memory and re-loading software constructs. As a result, in many cases, the operating environment, as well as much or all of the data that was resident in memory at the time of the fault, are lost. The system is therefore incapable of re-starting execution at the point of failure. This is unacceptable in applications that require very long times between system stops.

In addition, commodity OS's such as UNIX and Linux allow operators a large degree of freedom and flexibility to control and manage the system. For instance, a user within an UNIX environment may enter a command from a shell prompt that could delete a large amount of data stored on mass storage devices without the system either intervening or providing a warning message. Such actions may be unintentionally initiated by novice users who are not familiar with the often cryptic command shell and other user interfaces associated with these operating systems. In such situations, it is important to restrict access to the underlying infrastructure to ensure security and reliability.

In some cases, these concerns are addressed by executing a mainframe emulator upon a Linux operating system that is in turn executing upon commodity instruction processors. One example arrangement of such an emulated environment is illustrated in FIG. 1. In that arrangement, a server 10 includes a firmware layer 12, an interface layer 14, and an installation layer 16. The firmware layer 12 is communicatively connected to the interface layer 14, as is the installation layer 16. The firmware layer 12 and installation layer 16 can be used for booting the server 10, as well as starting one or more system services required to interact with hardware present in the server 10. The interface layer 14 generally represents an operating system maintaining the interface between hardware resources of the server 10, and includes an emulator 18, as well as hardware interface systems such as one or more I/O drivers 20, as well as a memory management subsystem 22 and a clock 24. The hardware interface systems 20-24 generally are used by the interface layer 14 for generalized operation, and are made available to an emulated operating system 26 by the emulator 18 hosted within the interface layer 14. The emulated operating system 26 can in turn host execution or one or more applications 28a-x (in the illustration shown, 3 such applications 28a, 28b, and 28x are shown).

In operation, the server 10 cannot natively execute instructions of the emulated operating system 26 or applications 28a-x, as they are written using a different instruction set architecture that is incompatible with that provided by the server 10. Accordingly, the emulator 18 fetches one non-native (e.g., mainframe) instruction at a time from emulated main memory (via an interface to the memory management subsystem 22), and translates that instruction to one or more native instructions of the instruction set architecture supported by the server 10. The server 10 then executes the instruction using the native instruction set architecture.

Typically when executing software on a computing system, it is necessary to ensure that the computing system is capable of performing each of the operations required by the software. This is especially the case when mainframe software is executed, because that type of software typically is required to have a higher degree of reliability and less tolerance for downtime. In general three levels of debug and test are necessary to verify that the translation mechanism is working correctly: unit testing, product testing, and system testing. Such testing features typically must be accounted for in a system that executes or emulates a mainframe system, to ensure continued reliability. This is often inconsistent with execution on a commodity system, which is typically not as robust as a mainframe system.

To validate operation of an emulated system such as that shown in FIG. 1, a testing arrangement 50 has been used, in which one or more architecture tests 52 are loaded into a loader component 54. The loader component 54 determines a current state of memory, registers, and other resources of a non-native system whose emulated operation is under test. The loader component 54 passes the state information to a driver 56, which instantiates and controls operation of an emulator 58. The emulator 58 receives the memory, register, and resource states, and executes the test by translating the non-native instructions within the emulator into native instructions on an instruction-by-instruction basis. As instructions are executed, data provided to the emulator 58 by the driver 54 is accessible to both the driver and emulator; as such, the driver 56 can monitor and extract results 60 of the architecture tests 52 from that memory.

Some efforts have been taken to improve the performance of an emulated system, for example to allow for replacement of such higher-end mainframe systems. Generally, these efforts are focused on reducing the number of cycles required of the commodity instruction processor to perform the tasks required by the emulated mainframe system. For example, in some cases, emulation systems incorporate real time translation engines which perform a one-for-one translation between each instruction in the emulated instruction set architecture (i.e., the mainframe architecture) and the native instruction set architecture (i.e., the instruction set architecture of the commodity device). This approach generally results in slow performance, due to the overhead required by “on the fly” translation. In other cases, a strictly static translation is performed prior to operation. However, even in these newer arrangements, testing would be required to validate operation of such alternative systems.

An arrangement such as the one shown in FIG. 2 is sufficient for testing an emulator that executes on an instruction-by-instruction basis; however, this testing may be insufficient in cases where advanced techniques for improving performance are employed. This is because the test arrangement 50 tests execution of dynamically-translated instructions within an emulator, rather than accommodating any flexibility regarding static or partially static translation techniques, or execution of translated instructions external to an emulator. As such, the existing testing systems for instruction-by-instruction emulation are insufficient where emulation does not take place on an instruction-by-instruction basis.

For these and other reasons, improvements are desirable.

### SUMMARY

In accordance with the following disclosure, the above and other issues are addressed by the following:

In a first aspect, a method includes translating one or more banks of non-native instructions into one or more banks of native instructions executable in a computing system having a native instruction set architecture. The one or more banks of non-native instructions define one or more tests of execution of a non-native instruction set architecture. The method also includes loading a memory with instructions and data defined according to the non-native instruction set architecture and addressed by the one or more tests, and triggering, by an emulator, execution of the translated one or more banks of native instructions. The method further includes, upon detection of an error during execution of the translated one or more banks of native instructions, identifying an error in execution of the non-native instruction set architecture by the computing system.

In a second aspect, a system executable on a computing device having a native instruction set architecture is disclosed. The system includes a testing component and an emulator component. The testing component is capable of managing execution of an emulator through a software debugger, and configured to load one or more transplant files into the emulator component. The transplant files represent instructions and data organized according to a non-native instruction set architecture. The emulator component is configured to load a bank of translated instructions executable on a native instruction set architecture, the bank of translated instructions derived from a corresponding bank of non-native instructions representing one or more tests of the non-native instruction set architecture.

In a third aspect, a computer-implemented method operable on a computing system is disclosed. The computer-implemented method includes translating one or more banks of non-native instructions into a set of source code instructions, the one or more banks of non-native instructions defining one or more self-checking executable tests of execution of instructions defined in a non-native instruction set architecture. The computer-implemented method also includes compiling the set of source code instructions to generate translated one or more banks of native instructions, and loading a memory with one or more transplant files including instructions and data organized according to the non-native instruction set architecture. The one or more transplant files include a representation of memory, a representation of a state of the instruction processor, and a pointer patch table, the representation of memory addressed by the one or more tests. The computer-implemented method further includes triggering, by an emulator, execution of the translated one or more banks of native instructions, and, upon detection of an error during execution of the translated one or more banks of native instructions, identifying an error in execution of the non-native instruction set architecture by the computing system.

### BRIEF DESCRIPTION OF THE DRAWINGS

FIG. 1 illustrates a prior art computing system in which one or more non-native software programs can be emulated;

FIG. 2 illustrates a prior art debug system useable in connection with the computing system of FIG. 1;

FIG. 3 illustrates a just-in-time static translation emulation system operable within a computing system, according to a possible embodiment of the present disclosure;

FIG. 4 illustrates a portion of an example computing system in which the just-in-time static translation emulation system can be implemented;

FIG. 5 illustrates a system for testing a just-in-time static translation emulation system, according to an example embodiment of the present disclosure;

FIG. 6 illustrates a debugger executable with the system for testing disclosed in FIG. 5;

FIG. 7 illustrates a portion of an example computing system in which the just-in-time static translation emulation system can be tested;

FIG. 8 illustrates an electronic computing device with which aspects of the just-in-time static translation emulation system can be implemented; and

FIG. 9 illustrates a method for debugging a just-in-time static translation emulation system, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to methods and systems for debugging a “just-in-time” static translation emulation system. The methods and systems described herein provide for debug and testing of a system that executes a translated native version of instructions originally written in a non-native instruction set for a non-native instruction set architecture. The methods and systems disclosed herein allow a developer or other user associated with an emulator to validate correct translation of non-native instructions into native instructions, such that, although the entire native instruction set may or may not be validated, the instructions and instruction sequences used in place of non-native instructions are validated, as well as proper translation from the non-native instructions into native instructions, in a bank-based arrangement.

I. Just-in-Time Static Translation Systems

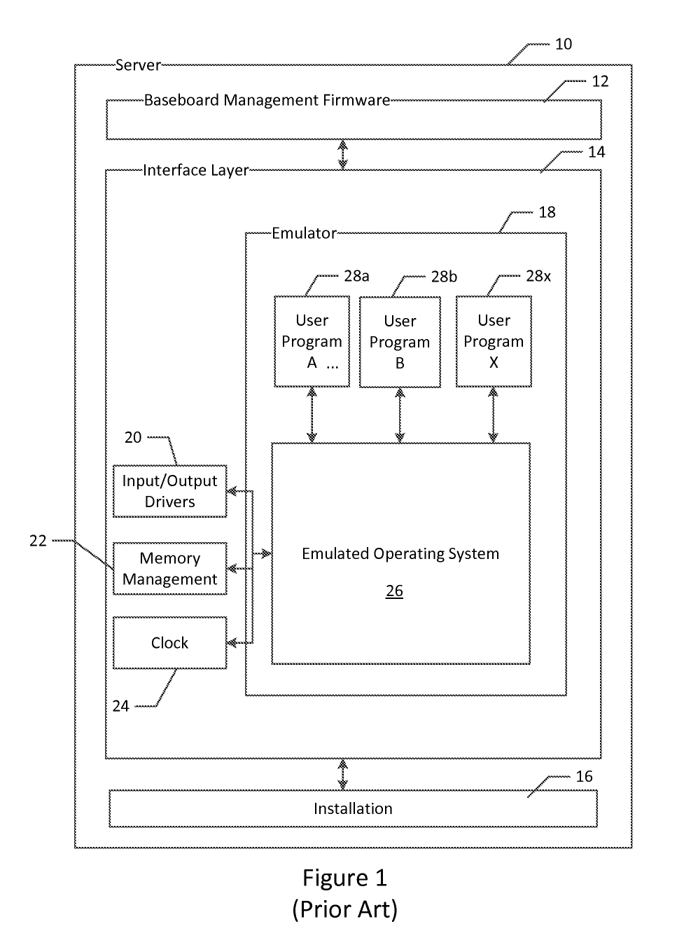

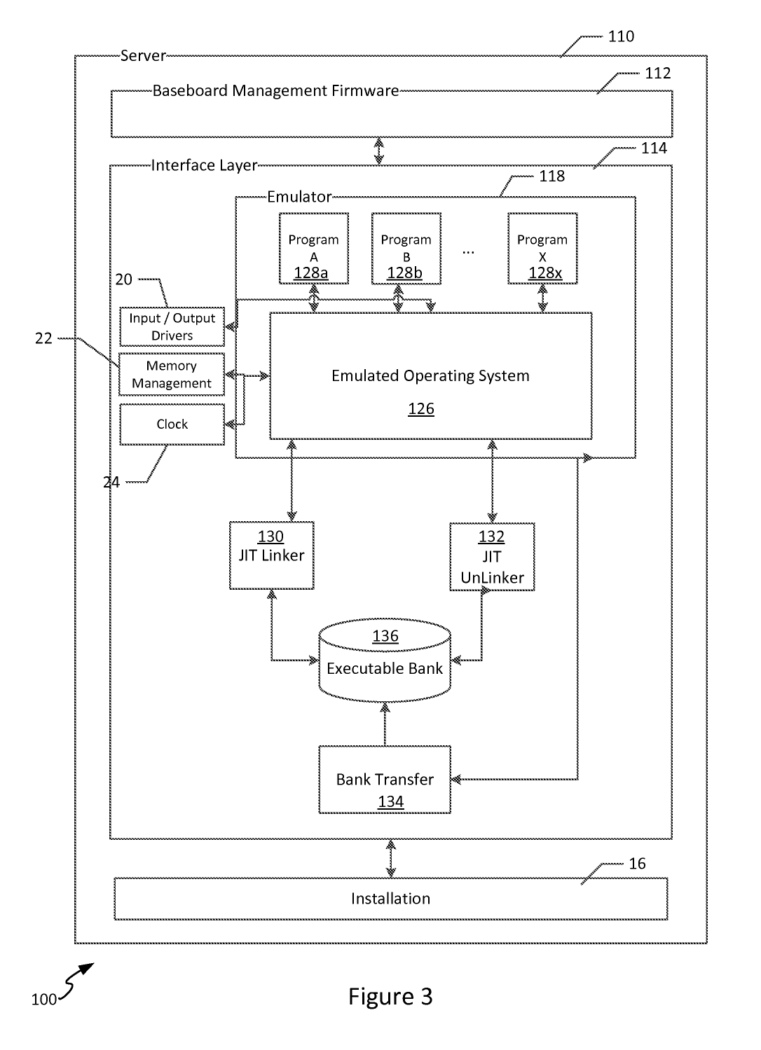

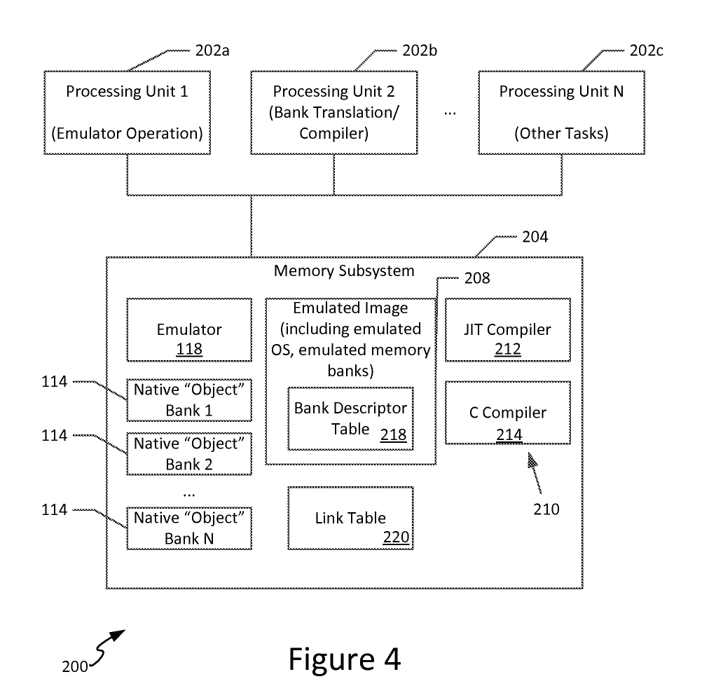

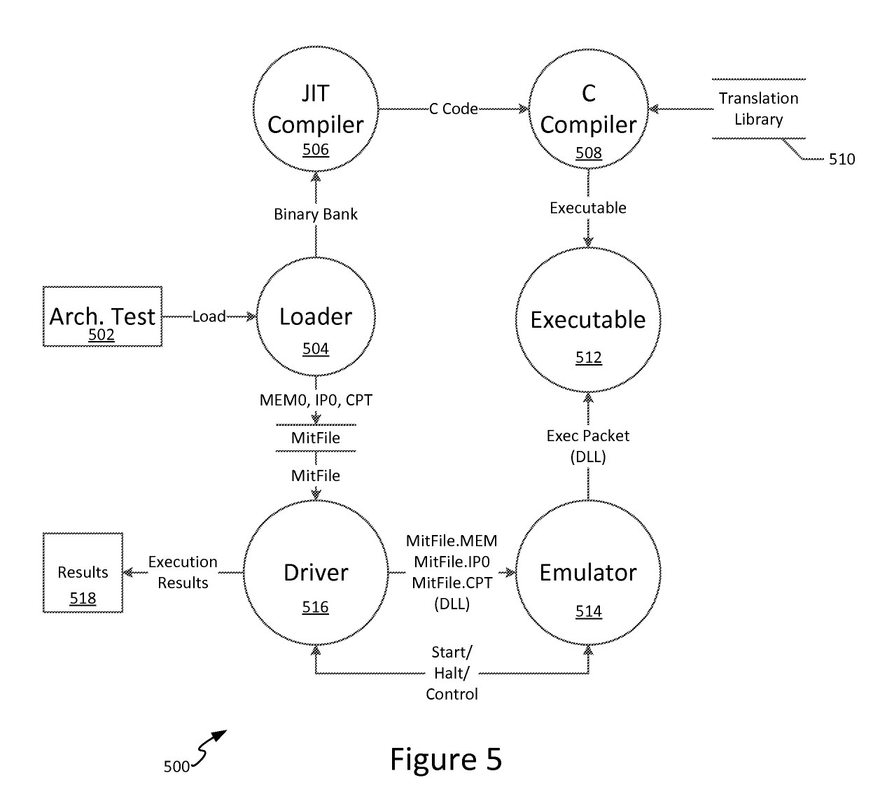

Referring now to FIGS. 3-4, aspects of a just-in-time (“JIT”) static translation emulation system are shown. FIG. 3 illustrates a block diagram of a JIT static translation emulation system 100, operable within a computing system. The system 100, in contrast with the instruction-by-instruction emulation system 10 of FIG. 1, generally executes emulated code streams by pre-translating memory banks, and then natively executing those translated memory banks, rather than dynamically translating then executing the non-native binary code on an instruction-by-instruction basis. Accordingly, the systems disclosed in FIGS. 3-4, and as further discussed below, provides for improved execution efficiency as related to prior art systems, yet require testing and validation, examples of which are discussed in connection with FIGS. 5-9.

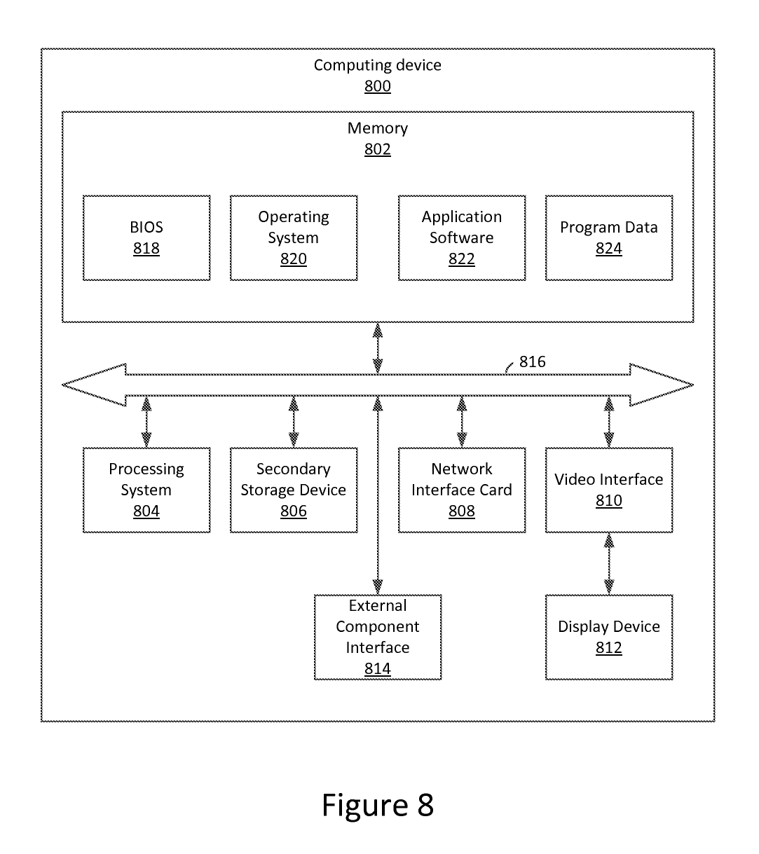

In the embodiment shown, the emulation system 100 executes on a server 110. An example server is described in further detail below in conjunction with FIG. 8; however, in general the server corresponds to a multi-processor computing system having a commodity instruction set architecture. In some embodiments of the present disclosure, the server 110 operates using an Intel-based instruction set architecture (e.g., IA32, IA32-x64, IA64, etc.); however, other instruction set architectures could be used.

In the embodiment shown, the server 110 includes a firmware layer 112, an interface layer 114, and an installation layer 116. The firmware layer 112 and the installation layer 116 are each communicatively connected to the interface layer 114. As with other emulation systems, the firmware layer 112 and installation layer 116 can be used for booting the server 110, as well as starting one or more system services required to interact with hardware present in the server 110. The interface layer 114 generally represents an operating system maintaining the interface between hardware resources of the server 110. The interface layer 114 can be, in certain embodiments, an operating system compiled for execution on a native instruction set architecture, such as a Linux- or Unix-based operating system. In alternative embodiments, other operating systems could be used, such as a Windows operating system provided by Microsoft Corporation of Redmond, Wash.

In the embodiment shown, the interface layer 114 includes an emulator 118, as well as hardware interface systems such as one or more I/O drivers 120, as well as a memory management subsystem 122 and a clock 124. The hardware interface systems 120-124 generally are used by the interface layer 114 for generalized operation, and are made available to an emulated operating system 126 by the emulator 118 hosted within the interface layer 114. Any of a variety of emulated operating systems can be used, such that the emulated operating system is implemented using a non-native instruction set architecture. In one possible embodiment, the emulated operating system is the OS2200 operating system provided by Unisys Corporation of Blue Bell, Pa. Other emulated operating systems could be used as well, but generally refer to operating systems of mainframe systems.

The emulated operating system 126 can host execution or one or more applications 128a-x (in the illustration shown, 3 such applications 28a, 28b, and 28x are shown). The applications 128a-x are generally maintained in a memory managed by the emulated operating system 126 by separating that memory into memory banks. In the context of the present disclosure, these memory banks are also referred to as non-native memory banks, or banks of non-native instructions. This means that the applications 128a-x defined by the instructions maintained in those banks are written for execution on a non-native instruction set architecture not directly executable by the server 110. Although the size of such memory banks may vary based on the emulated operating system used, in a possible embodiment each memory bank has a size of 262 k words. Other memory bank sizes may be used as well.

In contrast to prior art systems, the interface layer 114 as illustrated in this embodiment also includes a linker component 130, an unlinker component 132, and a bank transfer module 134, each of which are interfaced to one or more translated memory banks in a data store 136. The translated memory banks correspond to emulated, non-native memory banks managed by the emulated operating system 126, but are translated into native instructions, which can be directly executed on the server 110 without requiring further instruction-by-instruction translation.

The linker component 130 manages association of one or more of the translated memory banks in the data store 136 to the emulator 118, which selectively directs execution either (1) from a translated memory bank, natively on the server 110, or (2) based on instruction-by-instruction translation from a non-native memory bank defined by the emulated operating system 126, if no translated memory bank exists or is capable of being linked to the emulator 118.

The unlinker 132 disassociates translated memory banks from the emulator 118. For example, in certain embodiments, only a predetermined number of memory banks can be associated at once with the emulator, for example due to physical memory constraints of the server 110. In such circumstances, only a subset of the available translated memory banks in the data store 136 may be linked to the emulator 118 at once. When a maximum number of translated memory banks has been reached but operation of an application has transferred to an unlinked (but translated) memory bank, one of the currently linked memory banks is disassociated from the emulator 118 by the unlinker 132 (e.g., based on being a least recently used translated memory bank, or other analogous scheme). This will allow the linker 130 to associate the relevant unlinked translated memory bank with the emulator 118 for native execution on the server 110.

The bank transfer module 134 transfers memory banks of non-native instructions to the data store 136, where they can be accessed and translated by a translator component. Additional details regarding translation are provided below.

In use, when the emulator 118 fetches an instruction that transfers control from one bank to another a check is made to see if a translated version of that memory bank has been linked to the emulator 118 within the interface layer 114. If the bank has been linked, the emulator 118 will call the bank directly within the interface layer. The bank executes directly on the instruction processor associated with the server 110, and continues to execute within that environment until another bank transfer or an error exception occurs.

In certain embodiments, overall management of memory banks is provided by the emulated operating system 126, such that the emulated operating system defines one or more memory banks of non-native instructions forming an application to be executed; as needed, the emulated operating system can then trigger translation of the non-native instructions in a particular memory bank to native instructions. The emulated operating system 126 can, when the translated memory bank is formed, trigger operation of the linker 130 to link the translated memory bank to the emulator 118, which can direct execution to occur from the native instructions included in that linked, translated memory bank. As such, the loading, linking, and unlinking of memory banks is controlled by the emulated operating system 126. This provides the necessary reliability in that the emulated operating system controls memory bank management, as opposed to allowing translation at a lower level (e.g., by the emulator 118 or interface layer 114.

It is noted that, if a problem occurs during translation of a memory bank or native execution from that memory bank, operation can revert to execution from an emulated memory bank of non-native instructions, using traditional instruction-by-instruction translation. The translated memory bank can then be examined for errors. Furthermore, the emulated operating system 126 can generate hash values associated with each of the translated memory banks, such that a mismatched hash value may indicate an error or tampering with that translated memory bank, and would trigger retranslation of the non-native version of that memory bank.

Additionally, by translating the memory banks to native instructions, those native instructions can be scheduled and executed using the interface layer 114 and instruction set architecture of the server 110. Accordingly, the particular instruction set architecture and organization of the processing units in the server 110 can be utilized, including registers, memory, out-of-order execution techniques, and other efficiencies that would otherwise be unavailable if instruction-by-instruction translation in an emulator were the only mechanism available. However, each of these alternative techniques require debug and validation, for example using the systems and methods disclosed in FIG. 5-9 below.

Referring now to FIG. 4, a portion of an example computing system 200 is shown in which the just-in-time static translation emulation system can be implemented. The example computing system 200 represents a portion of a system, such as server 110 of FIG. 3, which can manage execution of the just-in-time (“JIT”) static translation emulation system 100. In the embodiment shown, the example computing system 200 includes a plurality of programmable circuits, shown as processing units 202a-x (referred to collectively as processing units 202).

In the embodiment shown, each of the processing units 202 is communicatively connected to a memory subsystem 204. The memory subsystem includes an emulator 118, which is configured to translate and execute an emulated image 208. The emulated image 208 can include, for example, a non-native operating system and associated non-native applications managed by the non-native operating system. For example, the emulated image 208 can represent a mainframe operating system, such as the OS2200 operating system from Unisys Corporation of Blue Bell, Pa., as well as one or more applications designed for operation using that operating system and its associated instruction set architecture.

The memory subsystem further includes the emulator 118 described above, as well as a translator component 210 that includes a just-in-time (“JIT”) compiler 212 and a C compiler 214. The translator component 210 is configured to receive an indication from the emulated operating system (during execution of the emulated image 208 within emulator 118) of the existence of a non-native memory bank. The translator component 210 converts the non-native memory bank to a native, or “translated” memory bank. In an example implementation, a JIT compiler 212 in the translator component 210 parses the instructions and data in the non-native memory bank, and translates those non-native instructions to source code. As a second step, a C compiler 214 (or other equivalent compiler), compiles the source code into native instructions, resulting in a translated, native memory bank, translated on an instruction-by-instruction manner. In the embodiment shown, a plurality of translated memory banks 216a-n are shown (illustrated as native “object” banks generated from emulated memory banks within the emulated image 208), following translation by the translator component 210. In example embodiments, the translated memory banks 216a-n are stored in files managed within an interface layer or other native operating environment, while non-native memory banks are managed within the emulated image 208. Other embodiments providing for management of memory structures are possible as well.

In addition to the above-discussed memory structures, the memory subsystem 204 further includes a bank descriptor table (“BDT”) 218 and a link table 220. The bank descriptor table 218 is generated and managed within the emulated operating system, and stores information about available banks for management by the emulated operating system. The link table 220 tracks which of the translated memory banks are linked to an interface layer operating within the interface layer; in other words, the link table manages translated, native memory banks while the bank descriptor table 218 manages the emulated, non-native memory banks included within the emulated image 208. In example embodiments, the bank descriptor table 218 can contain indexed entries to each of the banks managed by an emulated operating system, including information regarding the usage of the bank, its address, and additionally a link bit defining whether the bank has an equivalent translated version that is directly executable on the interface layer. Analogous fields can be included in the link table, such as a link bit, an index, and a timestamp (for tracking the oldest linked memory bank for bank management purposes).

During typical operation, execution of an emulator 118 and associated non-native applications hosted within that emulator are assigned to a particular programmable circuit 202. In the embodiment shown, execution of the emulated image 208 within an emulator is assigned to processing units 202a, while translation performed by the translator component 210 can be offloaded to a different processing unit 202b. In this way, the first processing unit 202a is dedicated to executing the emulated image 208, such that a minimum amount of overhead (i.e., time not dedicated to direct execution of the emulated, mainframe system defined by the emulated image 208) is required.

Additional aspects of execution of pre-translated banks of instructions are discussed in further detail in copending U.S. patent application Ser. No. ______ entitled “Just-In-Time Static Translation System for Emulated Computing Environments”, the disclosure of which is hereby incorporated by reference in its entirety.

II. Testing Infrastructure

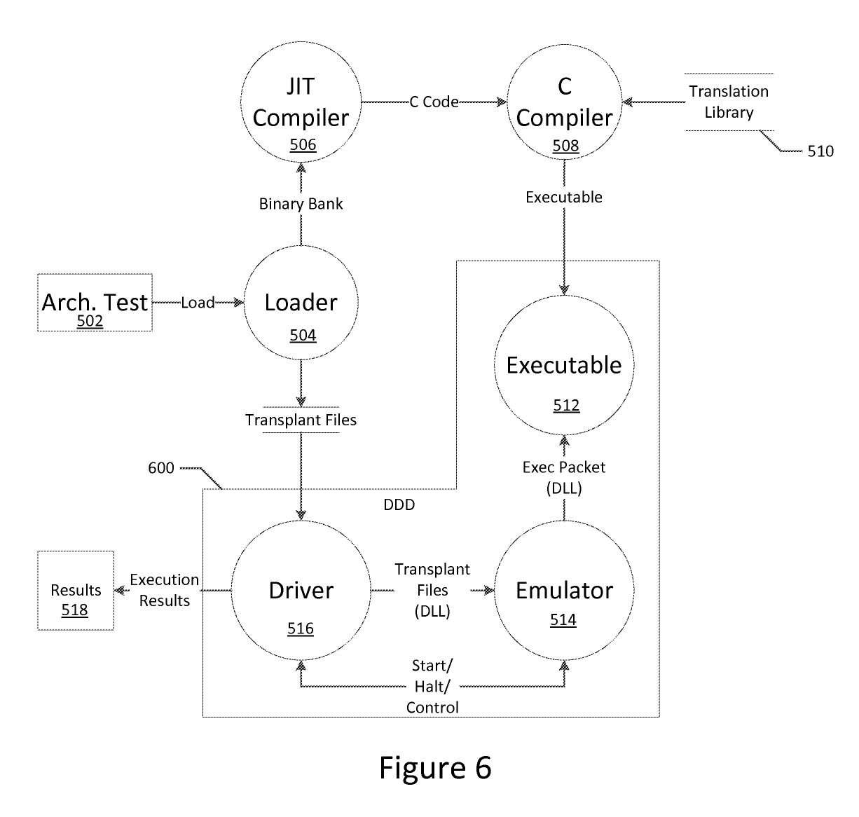

Referring now to FIGS. 5-6, a system 500 and related debugger 600 for testing a just-in-time static translation emulation system, such as the one illustrated in FIGS. 3-4, are illustrated. In general, the system 500 includes an architecture test 502 received at a loader component 504. The architecture test 502 can, in certain embodiments, include a series of tests designed to assess operation of a particular instruction set architecture. In an example embodiment, the architecture test 502 includes a set of one or more predefined tests that can be performed on a particular instruction set architecture to assess correct instruction of each of the instructions of a particular instruction set architecture. In such an embodiment, the architecture test 502 can be a self-checking executable capable of execution either in a particular instruction set architecture, or within an emulator executing that instruction set architecture, as illustrated in connection with FIG. 4. The architecture test 502 can include a number of features which output indications of proper or erroneous execution when the test is executed, for example by displaying a number of subtests and errors encountered, generating a report buffer, or other operations.

The loader component 504 receives the architecture test 502 and prepares it for execution within an emulation environment. In some embodiments, the loader component 504 generates a set of transplant files based on the architecture test. The transplant files define a state of a system's memory, instruction processor, and C-pointer patch table, to replicate a state of a system that would execute the test 502. The state of the system's memory can include, for example, instructions and data stored in a format recognizable to a system affiliated with the architecture test; in embodiments where the architecture test 502 is written in a non-native instruction set architecture the instructions and data could be stored in a format affiliated with that non-native instruction set architecture. The transplant files can be, in some embodiment, stored in a text or ASCII formatted file.

The loader component 504 also passes the architecture test to a first compiler 506, which receives the architecture test 502 and translates the test from its original instruction set architecture (i.e., in the case of emulation, a non-native instruction set architecture), from the non-native instruction set to a source code instruction set (e.g., C/C++ source code). Optionally, the first compiler 506, also referred to as the JIT compiler, can generate source code including one or more inline non-native instructions or remote procedure calls, reserved for later translation. To perform this translation, the first compiler 506 optionally passes through the code of the architecture test 502 two or more times. In general, the first compiler 506 will read in an input bank file containing the desired architecture test 502, and place that file into an array. The lower and upper address limits of that input bank are then computed, and the entire bank is decoded instruction by instruction. This can include multiple passes across the array. A first pass can be used to locate jumps and internal transfers between banks, for example in the case of receiving a jump instruction or local procedure call. These instructions can be converted to a source code labeled instruction relating to a jump condition. Basic, arithmetic instructions can be located in a second pass and implemented as inline instructions, allowing a second compiler 508 to call a translation library 510, which contains correspondences between the non-native instructions (now defined as source code inlines) and native instructions. A jump table (i.e., defining destinations of jump instructions), boundaries of execute tables, and variables can be computed, and then code for each instruction is generated alongside the computed jump table.

In an example embodiment, the following set of instructions may be included in a particular architecture test 502, which, in the example shown, is originally written in a non-native, OS2200 instruction set architecture:

| | | |
|---|---|---|
| -000032003161 | LA | A2, *05, X10, B1 |
| -000032003162 | TLE, U | A2, 045 |
| -000032003163 | J | 03332 |
| -000032003164 | SR | R1, *04, X10, B1 |
| -000032003165 | LR, U | R1, 044 |
| -000032003166 | LBU | B8, *01, X10, B1 |
| -000032003167 | LA, U | A1, 06 |
| -000032003170 | AA | A1, X10 |
| -000032003171 | LA | A0, 0154,, B6 |
| -000032003172 | BIML | 01063,, B0 |
| -000032003173 | SA | A0, 0154,, B6 |
| -000032003174 | SA | A0, *010, X10, B1 |
| -000032003175 | LXLM | A2, *06, X10, B1 |
| -000032003176 | LXSI, U | A2, 0 |
| -000032003177 | TNZ | A2 |
| -000032003200 | EX | 02655,, B0 |
| -000032003201 | LA, S1 | A1, *06, X10, B1 |
| -000032003202 | TG, U | A1, 04 |
| -000032003203 | EX | 02661,, B0 |
| -000032003204 | MSI | A2, 01055, A1, B0 |
| -000032003205 | SA | A2, *012, X10, B1 |
| -000032003206 | AA, U | A2, 044 |
| -000032003207 | LA | A0,*05, X10, B1 |
| -000032003210 | TLE | A0, A2 |
| -000032003211 | EX | 02654,, B0 |
| -000032003212 | TZ, S2 | *06, X10, B1 |
| -000032003213 | EX | 02651,, B0 |
| -000032003214 | LA | A0, *012, X10, B1 |
| -000032003215 | JZ | A0, 03224 |
| -000032003216 | LA | A1, A0 |
| -000032003217 | TNZ, S1 | 0162,, B6 |
| -000032003220 | TNZ, S4 | 0200,, B6 |
| -000032003221 | J | 03223 |
| -000032003222 | AA, U | A1, 044 |
| -000032003223 | TLE | A1, 0206, , B6 |
| -000032003224 | EX | 02454,, B0 |

A prelude, containing the corresponding addressing arrangement used in to establish the array, jump table, and eventual source code would be generated and executed, with the corresponding C code generated by the first compiler 506 appearing as follows:

L003161:

| | |
|---|---|
| LOGVA(Lg, “003161”); // 003161 100052210005 LA | A2,*05,X10,B1 |

| Icount_Inc; | |
|---|---|
| pAreg[2]=TranslateRead1(1,CalcAddrByX24_NoInc(10,05))[0]; | |
| LOGVA(Lg, “003162”); // 003162 547040000045 TLE,U | A2,045 |

| Icount_Inc; | |
|---|---|
| if(TestGreater(pAreg[2],045)) | |
| { | |
| LOGVA(Lg, “003163”); // 003163 746500003332 J | 03332 |

| Icount_Inc; | |
|---|---|
| JH_Update(0204751003163); | |
| goto L003332; | |
| } | |
| LOGVA(Lg, “003164”); // 003164 040032210004 SR | R1,*04,X10,B1 |

| Icount_Inc; | |
|---|---|
| TranslateWrite1(1,CalcAddrByX24_NoInc(10,04))[0]=pRreg[1]; | |
| LOGVA(Lg, “003165”); // 003165 237020000044 LR,U | R1,044 |
| Icount_Inc; | |
| pRreg[1]=044; | |
| LOGVA(Lg, “003166”); // 003166 750212210001 LBU | B8,*01,X10,B1 |

Icount_Inc;
{

ULONGLONG value=TranslateRead1(1,CalcAddrByX24_NoInc(10,01))[0];
if(value!=*abtIntPntrs[8])ip._LBU(8,value);

| } | |
|---|---|
| ReloadBaseReg(8); | |
| LOGVA(Lg, “003167”); // 003167 107020000006 LA,U | A1,06 |

| Icount_Inc; | |
|---|---|
| pAreg[1]=06; | |
| LOGVA(Lg, “003170”); // 003170 140020000012 AA | A1,UX10 |
| Icount_Inc; | |
| AddRegister(pXreg+13,pGrs[UX10],(CDesignatorRegister*)pDR); | |
| LOGVA(Lg, “003171”); // 003171 100000060154 LA | A0,0154,,B6 |

| Icount_Inc; | |
|---|---|
| pAreg[0]=TranslateRead1(6,0154)[0]; | |
| LOGVA(Lg, “003172”); // 003172 736220001063 BIML | 01063,,B0 |

Icount_Inc;
BIML((CBitStringDescriptor*)(pBreg0+01063), pXreg, pRreg,

(CDesignatorRegister*)pDR, Addressing_Control);

| LOGVA(Lg, “003173”); // 003173 010000060154 SA | A0,0154,,B6 |
|---|---|
| Icount_Inc; | |
| TranslateWrite1(6,0154)[0]=pAreg[0]; | |
| LOGVA(Lg, “003174”); // 003174 010012210010 SA | A0,*010,X10,B1 |

| Icount_Inc; | |
|---|---|
| TranslateWrite1(1,CalcAddrByX24_NoInc(10,010))[0]=pAreg[0]; | |
| LOGVA(Lg, “003175”); // 003175 755752210006 LXLM | A2,*06,X10,B1 |

Icount_Inc;

pXreg[14]=MergeLM(pXreg[14],TranslateRead1(1,CalcAddrByX24_NoInc(10,06))[0]
);

| | |
|---|---|
| LOGVA(Lg, “003176”); // 003176 517340000000 LXSI,U | A2,0 |

| Icount_Inc; | |
|---|---|
| pXreg[14]=MergeSI(pXreg[14],00); | |
| LOGVA(Lg, “003177”); // 003177 500220000016 TNZ | UA2 |

| Icount_Inc; | |
|---|---|
| if(TestNotZero(pGrs[UA2]))goto L003201; | |
| LOGVA(Lg, “003200”); // 003200 736120002655 EX | 02655,,B0 |

| Icount_Inc; | |
|---|---|
| LOGVA(Lg, “003200”); // 003200 745520022054 LMJ | X5,022054 |

Icount_Inc;
pXreg[5]=MergeH2(pXreg[5],03201);
JH_Update(0204751003200);
goto L022054;

L003201:

| | |
|---|---|
| LOGVA(Lg, “003201”); // 003201 106432210006 LA,S1 | A1,*06,X10,B1 |

Icount_Inc;
pAreg[1]=ShiftS1 (TranslateRead1(1,CalcAddrByX24_NoInc(10,06))[0]);

L003202:

| | |
|---|---|
| LOGVA(Lg, “003202”); // 003202 557020000004 TG,U | A1,04 |

| Icount_Inc; | |
|---|---|
| if(TestGreater(pAreg[1],04))goto L003204; | |
| LOGVA(Lg, “003203”); // 003203 736120002661 EX | 02661,,B0 |

| Icount_Inc; | |
|---|---|
| LOGVA(Lg, “003203”); // 003203 745520022054 LMJ | X5,022054 |

Icount_Inc;
pXreg[5]=MergeH2(pXreg[5],03204);
JH_Update(0204751003203);
goto L022054;

L003204:

| | |
|---|---|
| LOGVA(Lg, “003204”); // 003204 310055001055 MSI | A2,01055,A1,B0 |

Icount_Inc;
pAreg[2]=MultiplySingle(pAreg[2],

TranslateRead1(0,CalcAddrByX18_NoInc(13,01055))[0]);

L003205:

| | |
|---|---|
| LOGVA(Lg, “003205”); // 003205 010052210012 SA | A2,*012,X10,B1 |

| Icount_Inc; | |
|---|---|
| TranslateWrite1(1,CalcAddrByX24_NoInc(10,012))[0]=pAreg[2]; | |
| LOGVA(Lg, “003206”); // 003206 147040000044 AA,U | A2,044 |

| Icount_Inc; | |
|---|---|
| AddRegister(pXreg+14,044,(CDesignatorRegister*)pDR); | |
| LOGVA(Lg, “003207”); // 003207 100012210005 LA | A0,*05,X10,B1 |

| Icount_Inc; | |
|---|---|
| pAreg[0]=TranslateRead1(1,CalcAddrByX24_NoInc(10,05))[0]; | |
| LOGVA(Lg, “003210”); // 003210 540000000016 TLE | A0,UA2 |

| Icount_Inc; | |
|---|---|
| if(TestLessThanOrEqual(pAreg[0],pGrs[UA2]))goto L003212; | |
| LOGVA(Lg, “003211”); // 003211 736120002654 EX | 02654,,B0 |

| Icount_Inc; | |
|---|---|
| LOGVA(Lg, “003211”); // 003211 745520022054 LMJ | X5,022054 |

Icount_Inc;
pXreg[5]=MergeH2(pXreg[5],03212);
JH_Update(0204751003211);
goto L022054;

L003212:

| | |
|---|---|
| LOGVA(Lg, “003212”); // 003212 506152210006 TZ,S2 | *06,X10,B1 |

Icount_Inc;
if(TestZero(ShiftS2 (TranslateRead1(1,CalcAddrByX24_NoInc(10,06))[0])))goto

003214;
L003213:

| | |
|---|---|
| LOGVA(Lg, “003213”); // 003213 736120002651 EX | 02651,,B0 |

| Icount_Inc; | |
|---|---|
| LOGVA(Lg, “003213”); // 003213 745520022054 LMJ | X5,022054 |

Icount_Inc;
pXreg[5]=MergeH2(pXreg[5],03214);
JH_Update(0204751003213);
goto L022054;

L003214:

| | |
|---|---|
| LOGVA(Lg, “003214”); // 003214 100012210012 LA | A0,*012,X10,B1 |

Icount_Inc;
pAreg[0]=TranslateRead1(1,CalcAddrByX24_NoInc(10,012))[0];

L003215:

| | |
|---|---|
| LOGVA(Lg, “003215”); // 003215 740000003224 JZ | A0,03224 |

Icount_Inc;
if(TestZero(pAreg[0]))
{
JH_Update(0204751003215);

goto L003224;

| } | |
|---|---|
| LOGVA(Lg, “003216”); // 003216 100020000014 LA | A1,UA0 |

| Icount_Inc; | |
|---|---|
| pAreg[1]=pGrs[UA0]; | |
| LOGVA(Lg, “003217”); // 003217 506620060162 TNZ,S1 | 0162,,B6 |
| Icount_Inc; | |
| if(TestNotZero(ShiftS1 (TranslateRead1(6,0162)[0])))goto L003221; | |
| LOGVA(Lg, “003220”); // 003220 505220060200 TNZ,S4 | 0200,,B6 |

Icount_Inc;
if(TestZero(ShiftS4 (TranslateRead1(6,0200)[0])))
{

L003221:

| | |
|---|---|
| LOGVA(Lg, “003221”); // 003221 746500003223 J | 03223 |

| Icount_Inc; | |
|---|---|
| JH_Update(0204751003221); | |
| goto L003223; | |
| } | |
| LOGVA(Lg, “003222”); // 003222 147020000044 AA,U | A1,044 |

Icount_Inc;
AddRegister(pXreg+13,044,(CDesignatorRegister*)pDR);

L003223:

| | |
|---|---|
| LOGVA(Lg, “003223”); // 003223 540020060206 TLE | A1,0206,,B6 |

Icount_Inc;
if(TestLessThanOrEqual(pAreg[1],TranslateRead1(6,0206)[0]))goto L003225;

L003224:

| | |
|---|---|
| LOGVA(Lg, “003224”); // 003224 736120002454 EX | 02454,,B0 |

| Icount_Inc; | |
|---|---|
| LOGVA(Lg, “003224”); // 003224 745520022054 LMJ | X5,022054 |

Icount_Inc;
pXreg[5]=MergeH2(pXreg[5],03225);
JH_Update(0204751003224);
goto L022054;

L003225:

Additionally, the corresponding jump table generated by the first

compiler 506 would be generated as follows, illustrating jump instructions :
JumpTable_Init:

{

JumpTable[03161]=(ULONGLONG)&&L003161 − _LE;
JumpTable[03201]=(ULONGLONG)&&L003201 − _LE;
JumpTable[03202]=(ULONGLONG)&&L003202 − _LE;
JumpTable[03204]=(ULONGLONG)&&L003204 − _LE;
JumpTable[03205]=(ULONGLONG)&&L003205 − _LE;
JumpTable[03212]=(ULONGLONG)&&L003212 − _LE;
JumpTable[03213]=(ULONGLONG)&&L003213 − _LE;
JumpTable[03214]=(ULONGLONG)&&L003214 − _LE;
JumpTable[03215]=(ULONGLONG)&&L003215 − _LE;
JumpTable[03225]=(ULONGLONG)&&L003225 − _LE;
Initialized=1;

}
if(JumpTable[ParOffset]==0)

CleanupAndExit(ParOffset);

goto *(JumpTable[ParOffset]+_LE);

LabelError:

{

char errstr[100];
fnLog(“XXXXXXXXXXXXXXXXXXXXX”);
sprintf(errstr,“Return address not found %06Lo\n”,ReturnAddr);
fnLog(errstr);
CleanupAndExit(ReturnAddr);

}

}

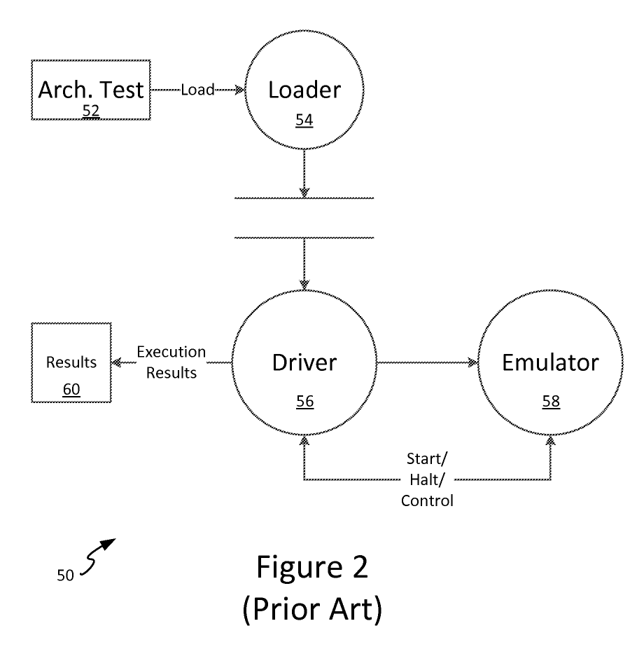

The second compiler 508 receives the translated source code and generates executable code 512 using the native instruction set of the system on which the test is to be executed (e.g., x86, IA64, ARM, etc). The second compiler 508 can call one or more corresponding translations of non-native instructions to native instructions using a translation library 510. Executable code 512 representing the translated, native instruction version of the selected test of the non-native instruction set architecture is output from the second compiler for execution using the JIT emulation arrangement discussed above in connection with FIGS. 3-4. As illustrated in FIGS. 5-6, the executable code 512 can be called from an emulator 514, which can be, in certain embodiments, emulator 118 of FIG. 3, with the code 512 representing a particular bank to be linked as the executable bank 136. However, when used in connection with the architecture tests 502, the code will typically be executed within a debugger. As illustrated in FIGS. 5-6, the transplant files generated by the loader component 504 are passed to a testing component, also referred to as driver 516. The testing component can be used to instantiate the emulator and load the emulator with the transplant files. This establishes a current memory state of the system to be emulated. In prior art systems, the emulator could then, as discussed in connection with FIG. 2, above, execute those instructions on an instruction-by-instruction basis. However, in accordance with the present disclosure, the emulator will call the executable code 512 as a bank to be linked and executed, thereby executing the test 502 of the non-native architecture as native code on a computing system having a native instruction set architecture.

In certain embodiments, the driver 516 can then extract results 518 from a memory managed within the emulator after execution of the test 502, to determine whether the test executed correctly. Example result output can be generated from the self-validating tests, and can include, for example, messages indicating whether an instruction processor was created correctly, whether a memory image was created and loaded correctly, whether and when a test is executed, and when test results are logged. The test results 518 can also be output to a separate file, and can include information such as the files loaded, results of checksum operations, output of statistics regarding memory used, and any errors that may be encountered during execution of the test.

It is recognized that during typical (non-testing) execution of a JIT static translation emulation system 100, execution will be allowed to continue, and will occur using a main executable allowed to continuously run on the computing system upon which the emulator is run. However, and as illustrated in FIG. 6, it is likely that in the context of architecture testing, the JIT static translation emulation system 100 will be run within a debugger 600. The debugger 600 can take many forms. In the example embodiment shown, the debugger 600 provides a shell from within which a user can create and load one or more tests, load transplant files, and then compile and step through the resulting natively executable code.

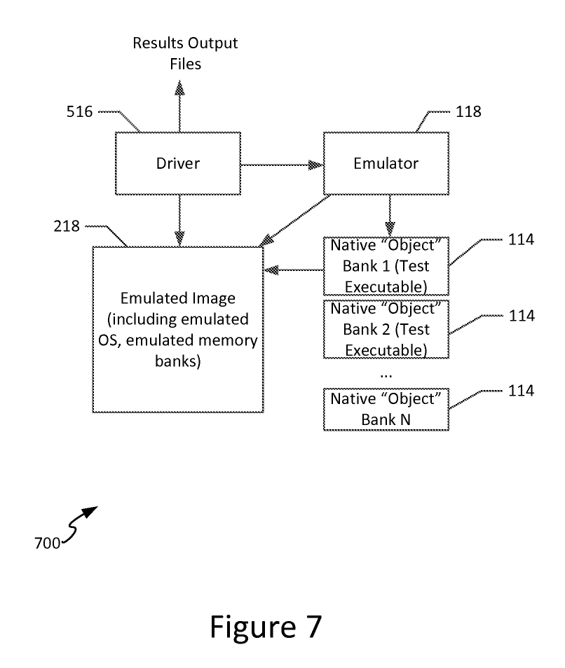

As illustrated in further detail in FIG. 7, the sequence of a debugging operation is illustrated in the context of a portion of a JIT static translation emulation system 700, which could be any of a variety of embodiments of a system such as those shown in FIGS. 3-4, above. In the example shown, a driver 514 receives and loads an emulated image 218, for example from transplant files received from a loader component. The driver 516 calls an emulator 118, which in turn calls a native bank of instructions 114. In this example, the native bank of instructions 114 contains an architecture test, as generated by the first and second compilers 506, 508 of FIGS. 5-6. The architecture test is executed as native code on a computing system having a compatible, native instruction set architecture (e.g., an x86 based instruction set architecture). Upon completion, the native bank 114 returns control to the emulator 118, which signals completion of the test. The driver 516 can then directly access the emulated image 218 to extract data from that emulated image. Based on that data, and output from the natively executed code 114, the driver can generate a set of one or more result files representing the outcome of the architecture test.

Referring now to FIG. 8, a block diagram illustrating an example computing device 800 is shown, which can be used to implement aspects of the present disclosure. In particular, the computing device 800 can represent a server, such as server 110 of FIG. 3, or a multiprocessor computing system, such as system 200 of FIG. 3.

In the example of FIG. 8, the computing device 800 includes a memory 802, a processing system 804, a secondary storage device 806, a network interface card 808, a video interface 810, a display unit 812, an external component interface 814, and a communication medium 816. The memory 802 includes one or more computer storage media capable of storing data and/or instructions. In different embodiments, the memory 802 is implemented in different ways. For example, the memory 802 can be implemented using various types of computer storage media.

The processing system 804 includes one or more processing units. A processing unit is a physical device or article of manufacture comprising one or more integrated circuits that selectively execute software instructions. In various embodiments, the processing system 804 is implemented in various ways. For example, the processing system 804 can be implemented as one or more processing cores. In another example, the processing system 804 can include one or more separate microprocessors. In yet another example embodiment, the processing system 804 can include an application-specific integrated circuit (ASIC) that provides specific functionality. In yet another example, the processing system 804 provides specific functionality by using an ASIC and by executing computer-executable instructions.

The secondary storage device 806 includes one or more computer storage media. The secondary storage device 806 stores data and software instructions not directly accessible by the processing system 804. In other words, the processing system 804 performs an I/O operation to retrieve data and/or software instructions from the secondary storage device 806. In various embodiments, the secondary storage device 806 includes various types of computer storage media. For example, the secondary storage device 806 can include one or more magnetic disks, magnetic tape drives, optical discs, solid state memory devices, and/or other types of computer storage media.

The network interface card 808 enables the computing device 800 to send data to and receive data from a communication network. In different embodiments, the network interface card 808 is implemented in different ways. For example, the network interface card 808 can be implemented as an Ethernet interface, a token-ring network interface, a fiber optic network interface, a wireless network interface (e.g., Wi-Fi, WiMax, etc.), or another type of network interface.

The video interface 810 enables the computing device 800 to output video information to the display unit 812. The display unit 812 can be various types of devices for displaying video information, such as a cathode-ray tube display, an LCD display panel, a plasma screen display panel, a touch-sensitive display panel, an LED screen, or a projector. The video interface 810 can communicate with the display unit 812 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 814 enables the computing device 800 to communicate with external devices. For example, the external component interface 814 can be a USB interface, a FireWire interface, a serial port interface, a parallel port interface, a PS/2 interface, and/or another type of interface that enables the computing device 800 to communicate with external devices. In various embodiments, the external component interface 814 enables the computing device 800 to communicate with various external components, such as external storage devices, input devices, speakers, modems, media player docks, other computing devices, scanners, digital cameras, and fingerprint readers.

The communications medium 816 facilitates communication among the hardware components of the computing device 800. In the example of FIG. 8, the communications medium 816 facilitates communication among the memory 802, the processing system 804, the secondary storage device 806, the network interface card 808, the video interface 810, and the external component interface 814. The communications medium 816 can be implemented in various ways. For example, the communications medium 816 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 802 stores various types of data and/or software instructions. For instance, in the example of FIG. 8, the memory 802 stores a Basic Input/Output System (BIOS) 818 and an operating system 820. The BIOS 818 includes a set of computer-executable instructions that, when executed by the processing system 804, cause the computing device 800 to boot up. The operating system 820 includes a set of computer-executable instructions that, when executed by the processing system 804, cause the computing device 800 to provide an operating system that coordinates the activities and sharing of resources of the computing device 800. Furthermore, the memory 802 stores application software 822. The application software 822 includes computer-executable instructions, that when executed by the processing system 804, cause the computing device 800 to provide one or more applications. The memory 802 also stores program data 824. The program data 824 is data used by programs that execute on the computing device 800.

Although particular features are discussed herein as included within an electronic computing device 800, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, DDR4 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Generally, computer storage media represents a non-transitory storage location for data and/or computer executable-instructions. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

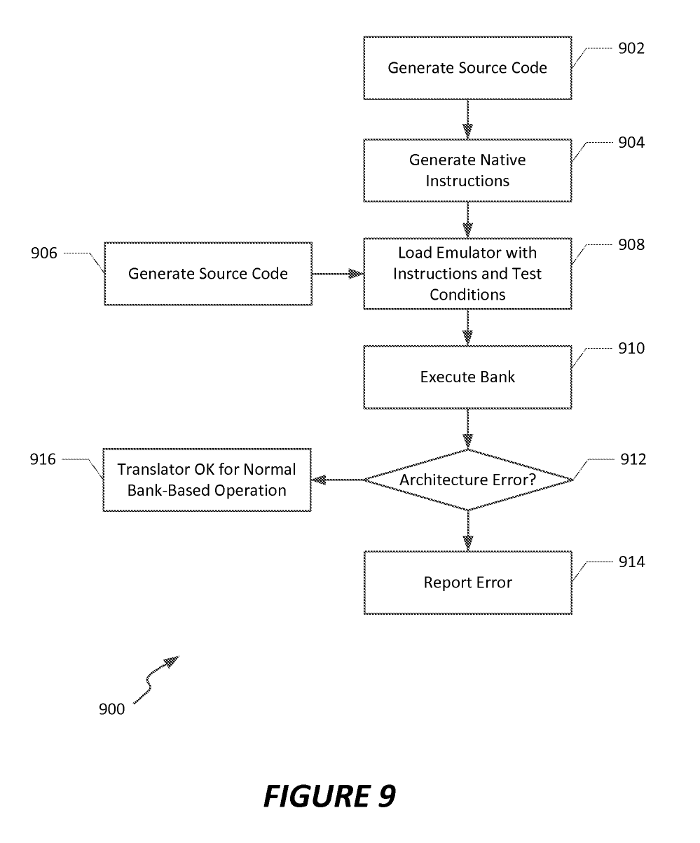

Referring now to FIG. 9, a method 900 for debugging a just-in-time static translation emulation system is shown, according to a possible embodiment of the present disclosure. The method 900 include generating source code from an architecture test written for a non-native instruction set architecture (step 902), and generating, from that source code, executable instructions of a native instruction set architecture (step 904). This can occur, for example, through use of first and second compilers, for example using the general process outlined above in connection with FIGS. 5-6.

The method 900 further includes generating instructions and data to be stored in a memory of a computing system having a native instruction set architecture, but in a memory structure configured according to a non-native instruction set architecture (step 906). In example embodiments, generating instructions and data can include generating one or more transplant files from selected code written in a non-native instruction set, for use on a native computing system (e.g., within the emulation systems as discussed herein). The method 900 also includes loading the emulator with the instructions and test conditions generated in step 906 (step 908), for example through use of a driver 516 or other analogous test component.

The method 900 includes execution of a selected bank of instructions called by an emulator (step 910), for example a bank of native instructions that have been pre-translated using first and second compilers in steps 902-904. Execution of the bank of instructions can include, for example, execution of one or more architecture tests, either in real time or within a debugger configured to manage flow control, breakpoints, and step-by-step code execution. During and after execution of the bank, architecture errors can be detected, for example by detecting erroneous data or operation of the bank of instructions (step 912). If architecture errors are detected, a reporting process can generate results indicating the nature of the error and location within the native translated bank where the error occurred (step 914). If no architecture errors are located, the reporting process outputs a report indicating no errors have been detected, and the translation process is considered to be ready for normal operation using JIT static translations of memory banks linked by the emulator (step 916).

It is recognized that, in embodiments of the present disclosure, the functions/acts noted in the blocks may occur out of the order as shown in FIG. 9. For example, two blocks shown in succession may in fact be executed substantially concurrently or the blocks may sometimes be executed in the reverse order, depending upon the functionality/acts involved.

Referring now to FIGS. 3-9 and the present disclosure overall, it is recognized that, through use of the methods and systems of the present disclosure, it is possible to debug a system using a JIT translation scheme by concurrently providing non-native memory space within which the test operates, and allowing a bank of native instructions representing a test of the non-native architecture to operate on that memory space. As such, bank-based operation can be assessed in addition to or in place of instruction-by-instruction execution, thereby allowing for validation and testing of higher-performance emulation systems.

The above specification, examples and data provide a complete description of the manufacture and use of the composition of the invention. Since many embodiments of the invention can be made without departing from the spirit and scope of the invention, the invention resides in the claims hereinafter appended.

1. A method comprising:
translating one or more banks of non-native instructions into one or more banks of native instructions executable in a computing system having a native instruction set architecture, the one or more banks of non-native instructions defining one or more tests of execution of a non-native instruction set architecture;
loading a memory with instructions and data defined according to the non-native instruction set architecture and addressed by the one or more tests;
triggering, by an emulator, execution of the translated one or more banks of native instructions; and
upon detection of an error during execution of the translated one or more banks of native instructions, identifying an error in execution of the non-native instruction set architecture by the computing system.

2. The method of claim 1, wherein translating one or more banks of non-native instructions into one or more banks of native instructions comprises:
translating the one or more banks of non-native instructions into a set of source code instructions; and
compiling the set of source code instructions to generate the translated one or more banks of native instructions.

3. The method of claim 2, wherein translating the one or more banks of non-native instructions into the set of source code instructions includes generating source code including one or more source code lines referencing a non-native instruction defined in an inline or procedure call.

4. The method of claim 2, wherein the set of source code instructions are associated with the bank of non-native instructions on a one-to-one basis.

5. The method of claim 1, further comprising generating in a loader component the instructions and data to be loaded into memory.

6. The method of claim 5, wherein the instructions and data are generated in one or more transplant files.

7. The method of claim 6, wherein the one or more transplant files include a representation of memory, a representation of a state of the instruction processor, and a pointer patch table.

8. The method of claim 7, wherein the pointer patch table includes a list of memory offsets pointing to a base address defined in the representation of memory.

9. The method of claim 8, further comprising creating a jump table associated with the bank of native instructions, the jump table associated with each of the branch instructions included within the non-native instructions.

10. The method of claim 1, wherein the one or more tests include a self-checking executable test.

11. The method of claim 1, wherein executing the one or more banks of translated instructions is directed by the testing component and includes instantiating the testing component within a debugger.

12. The method of claim 1, wherein triggering execution of the translated one or more banks of native instructions results in execution of the translated one or more banks of instructions on a computing system including a processor and memory, the processor configured to execute instructions in the native instruction set architecture.

13. A system executable on a computing device having a native instruction set architecture, the system comprising:
a testing component capable of managing execution of an emulator through a software debugger, the testing component configured to load one or more transplant files into an emulator component, the transplant files representing instructions and data organized according to a non-native instruction set architecture; and
an emulator component configured to load a bank of translated instructions executable on a native instruction set architecture, the bank of translated instructions derived from a corresponding bank of non-native instructions representing one or more tests of the non-native instruction set architecture.

14. The system of claim 13, wherein the testing component comprises a driver configured to control operation of the emulator.

15. The system of claim 13, wherein the bank of translated instructions executable on the native instruction set architecture comprises a native executable packet linked for execution by the emulator.

16. The system of claim 13, wherein the one or more tests represent tests of execution of all or substantially all of the instructions defined in the non-native instruction set architecture.

17. The system of claim 13, further comprising a loader component configured to generate the one or more transplant files, the one or more transplant files including a representation of memory, a representation of a state of the instruction processor, and a pointer patch table.

18. The system of claim 13, further comprising a first compiler configured to generate source code instructions from the bank of non-native instructions and a second compiler configured to generate the bank of translated instructions executable on the native instruction set architecture.

19. The system of claim 18, further comprising a translation library defining one or more correspondences between non-native instructions and native instructions.

20. A computer-implemented method operable on a computing system, the computer-implemented method comprising:
translating one or more banks of non-native instructions into a set of source code instructions, the one or more banks of non-native instructions defining one or more self-checking executable tests of execution of instructions defined in a non-native instruction set architecture;
compiling the set of source code instructions to generate translated one or more banks of native instructions;
loading a memory with one or more transplant files including instructions and data organized according to the non-native instruction set architecture, the one or more transplant files including a representation of memory, a representation of a state of the instruction processor, and a pointer patch table, the representation of memory addressed by the one or more tests;
triggering, by an emulator, execution of the translated one or more banks of native instructions; and
upon detection of an error during execution of the translated one or more banks of native instructions, identifying an error in execution of the non-native instruction set architecture by the computing system.
